(19) United States
(12) Patent Application Publication
(10) Pub. No.: US 2013/0280575 A1
(43) Pub. Date: Oct. 24, 2013

(54) TEMPERATURE-CONTROLLED BATTERY

(71) Applicants: Frank Obrist, Lustenau (AT); Christian Busch, Feldkirch (AT); Oliver Obrist, Dornbirn (AT)

(72) Inventors: Frank Obrist, Lustenau (AT); Christian Busch, Feldkirch (AT); Oliver Obrist, Dornbirn (AT)

(73) Assignee: OBRIST POWERTRAIN GMBH, Lustenau (AT)

(21) Appl. No.: 13/882,281

(22) PCT Filed: Sep. 13, 2011
(86) PCT No.: PCT/IB11/02149

§ 371 Date: Jul. 8, 2013

(30) Foreign Application Priority Data
Oct. 29, 2010 (CH) 01814/10

(51) Int. Cl. H01M 10/50; H01M 10/42

(52) U.S. Cl. CPC H01M 10/5016; H01M 10/4207; H01M 10/5095
USPC 429/120

(57) ABSTRACT

A temperature-controlled battery, for a vehicle drive, has numerous flat battery cells electrically interconnected and which are combined parallel to each other and are distributed in several battery chambers in a thermally insulated battery housing to form cell packages. Spacers are arranged between the battery cells. A flowable first heat-transfer medium in contact with the battery cells is enclosed in the battery housing. The first heat-transfer medium exchanges heat with a second heat-transfer medium enclosed in a channel system via the heat-transfer surfaces enclosed in the battery housing. The channel system has a supply line and a discharge line leading out of the battery for the temperature-controlled exchange of heat outside the battery. For forced convection at the battery cells, at least one pump is enclosed in the battery housing. The pump has a flow connection to the first heat transfer medium on the supply and outlet sides.

The invention relates to a temperature-controlled battery, in particular as an energy source for a vehicle drive, having numerous flat battery cells which are electrically connected to one another and are combined parallel in relation to one another and with spacers, which are arranged between said battery cells and are distributed in a plurality of battery chambers, in a thermally insulated battery housing to form cell packs, wherein a free-flowing first heat carrier which is in contact with the battery cells is enclosed in the battery housing, said first heat carrier exchanging heat with at least one second heat carrier, which is enclosed in a channel system, by means of heat-transfer areas which are enclosed in the battery housing, said second heat carrier having at least one feed and discharge line, which is routed out of the battery, for temperature-controlled heat exchange outside the battery, and at least one pump is enclosed within the battery housing for forced convection at the battery cells, said pump forming a flow connection with the first heat carrier on the inflow and outflow side.

A battery of this kind, through which a gaseous cooling medium flows, is disclosed by DE 10 2009 008 222. WO 2010053689 further discloses in each case providing plate bodies having a corrugated profile as spacers for forming spaces, which accommodate cooling liquid, between the battery cells of said battery. DE 102008061755 and DE102008027293 propose, for the purpose of fixing battery cells, arranging an elastically compressible intermediate layer in each case between two battery cells which are inserted into a battery chamber, said intermediate layer being composed of a nonwoven, a plastic foam material or a corrugated metal spring sheet, with the result that a contact pressure is produced after the battery cells, together with the compressible intermediate layer, are pressed in between metallic retaining walls which bound the battery chamber, said contact pressure maintaining the thermally conductive contact with said retaining walls and compensating for lateral expansion of the storage cells when they are charged and discharged. Consequently, it is possible to dissipate heat from the storage cells only by conducting heat along the metallic walls of the battery chamber to a cooled base plate of the battery. For the purpose of improving heat transfer from battery cells to a flowable heat carrier, DE 44 19 281 and EP 1 271 084 also disclose providing a plurality of plate bodies, which run parallel to one another and through which a coolant flows, in the battery.

The invention is based on the object of finding a battery of the type cited in the introductory part which ensures significantly improved heat supply to or heat dissipation from the battery cells, with the result that the battery is kept at an optimum operating temperature with an improved and more uniform temperature distribution, consequently can be subjected to higher loading and has a longer service life. According to the invention, said object is achieved on the basis of the characterizing features of patent claim 1. Advantageous embodiments of the invention are the subject matter of the dependent patent claims and can be found in the following description with reference to the drawings, in which:

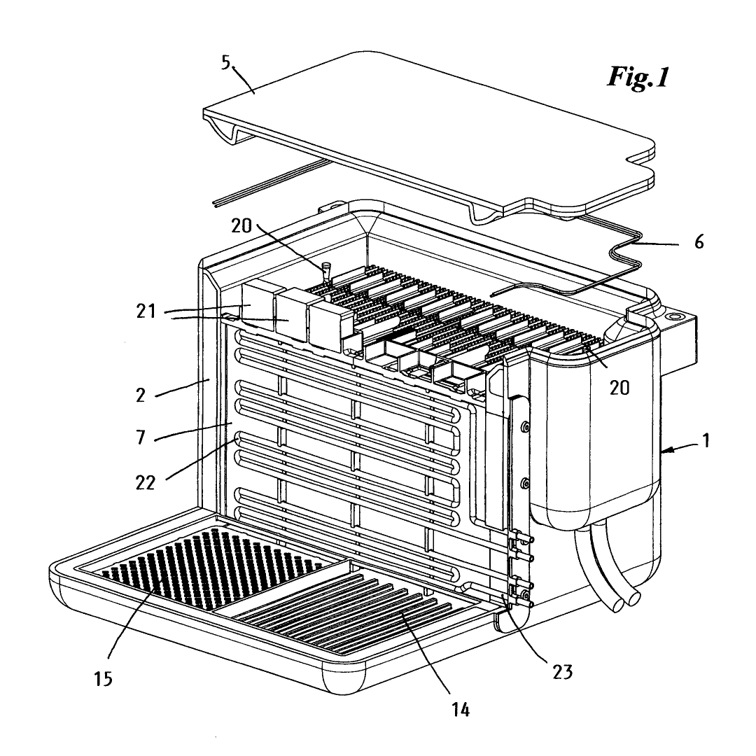

FIG. 1 shows a perspective illustration of the internal structure of a battery according to the invention in a detail shown parallel to the base of the battery and a perpendicular, central plane, with the battery cover raised,

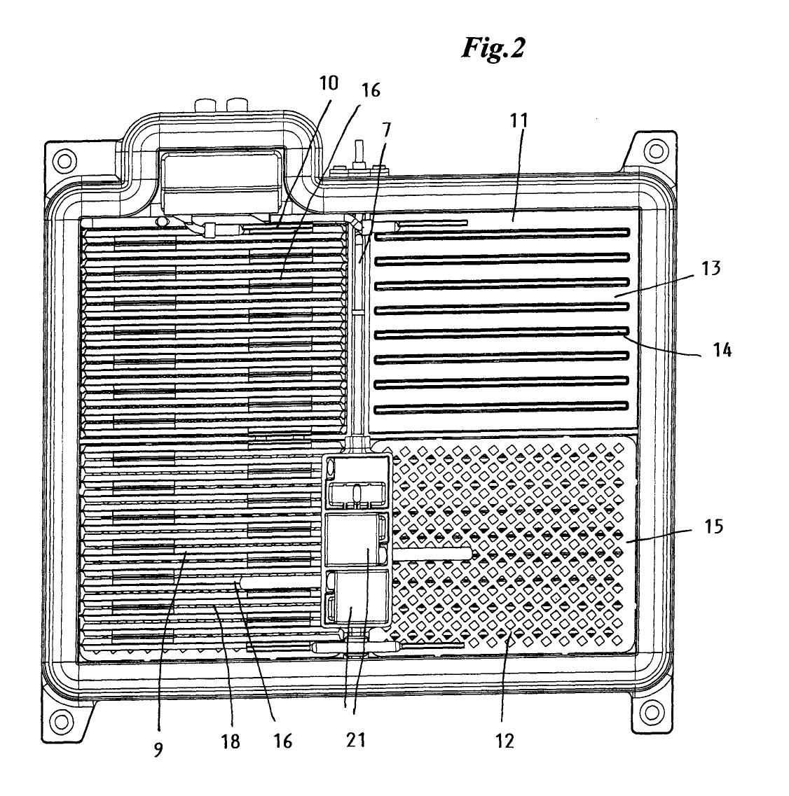

FIG. 2 shows a plan view of the open battery, with cell packs inserted only in one half and a base plate which is still partially missing,

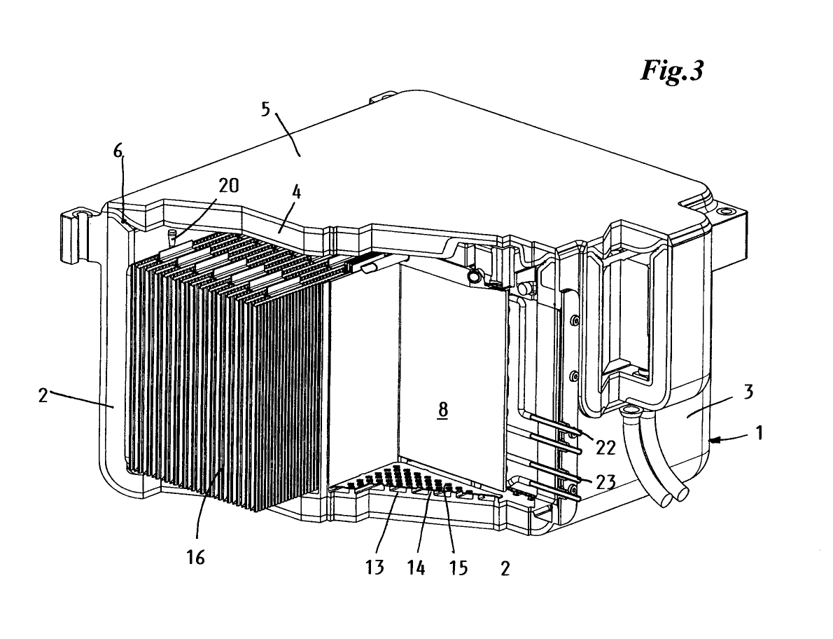

FIG. 3 shows a perspective view of the inside of the battery according to FIG. 1 on the basis of a partially broken-away illustration,

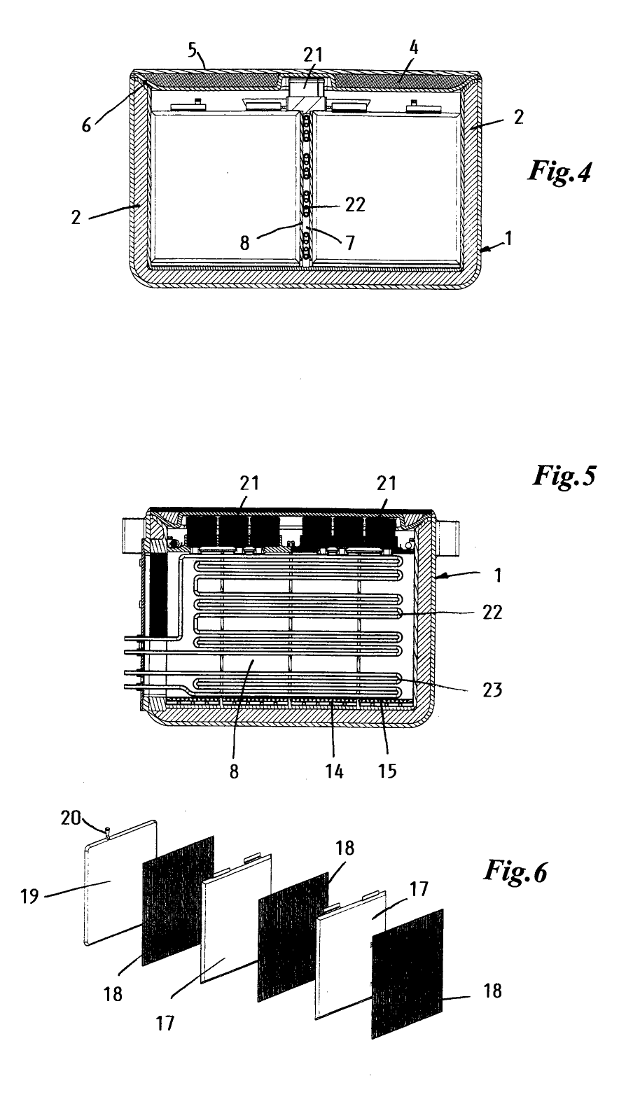

FIG. 4 shows a vertical section through the battery according to FIG. 1 transverse to internal heat exchanger tubes,

FIG. 5 shows a vertical section through the battery according to FIG. 1 parallel to heat exchanger tubes, and

FIG. 6 shows a perspective illustration of a few plate-like elements of the battery before they are combined to form a battery pack.

The battery 1 has a tub-like housing 3 which has an inner insulation layer 2 and which is closed in a sealed manner by a cover 5, which is fitted on and likewise has an insulation layer 4, with the aid of an inserted sealing strip 6. In this case, a clearance which remains beneath the cover 5 can be used for arranging a battery management system.

In the illustrated exemplary embodiment, the interior space in the battery housing 3 is divided into four battery chambers 9 to 12 by a central double wall 8, which forms a heat exchanger space 7, and two transverse walls which branch off laterally from said double wall. However, another layout with, for example, only one or two battery chambers and a laterally arranged double wall is likewise possible within the scope of the invention.

The housing base 13 is profiled by base ribs 14 which run parallel to one another and perpendicular to the double wall 8 and is fitted with a perforated plate 15 which is placed on said ribs, with the result that the, for example four, battery chambers 9 to 12 communicate with one another and with the heat exchanger space 7, which is formed by the double wall 8, along the profiled housing base 13.

Cell packs 16 are inserted into the battery chambers 9 to 12, said cell packs comprising a layered arrangement of pocket-like, flat battery cells 17 with metal sheets 18, which have a corrugated rib profile, arranged between them. Furthermore, a flat pressure pocket 19 which is filled with a compressed gas and is matched to the size of the battery cells is arranged in each cell pack 16, with the result that the battery cells 17 which are arranged in the battery chamber 9 to 12 in question are uniformly held in said battery chamber in a clamping manner under the pressure of the gas. Since the pressure pockets 19 are filled only after a cell pack 16 of this type is inserted into a battery chamber to 12, the cell packs 16 can be fitted in a particularly simple manner. To this end, each pressure pocket 19 has a filling nipple 20 which projects freely in the upward direction and can be closed in a sealed manner.

The corrugated metal sheet 18 is preferably composed of an aluminum alloy and is of relatively thin-walled design, with the result that it deforms under the pressure of the pressure pocket 19 and bears closely against the battery cells by way of its profile ribs for the purpose of good thermal conduction.

The profile ribs of the metal sheets 18 which are arranged between the battery cells 17 run in the vertical direction and therefore, in contact with the adjacent battery cells between them, form a corresponding number of vertical channels which adjoin the profiled housing base 13. Consequently, these channels which run along the battery cells 17 form a flow connection with the heat exchanger space 7, which is formed by the central double wall, by means of the housing base 13.

In order to achieve particularly effective heat exchange between the surface of the battery cells 17 and the liquid which is incorporated between them and the profiled metal sheet on account of this flow connection, a plurality of miniature pumps 21 are arranged next to one another in a row above the heat exchanger space 7, a liquid heat carrier, for example comprising transformer oil, being drawn upward out of the heat exchanger space 7 in the direction of the rising heat by said miniature pumps, with the result that said liquid heat carrier is drawn across the profiled housing base 13 and consequently from the lower region of the battery cells 17. In this case, the upwardly flowing heat carrier exchanges heat with cooling coils 22 which are arranged in the heat exchanger space 7 and which are connected to a heat exchanger which is provided outside the battery. In this case, in accordance with the illustrated exemplary embodiment, cooling coils 22, 23 of two systems, which are independent of one another and are operated with different heat carriers, can be provided in the heat exchanger space 7, by way of example cooling water flowing through one of said systems and the coolant of an air-conditioning system flowing through another of said systems. In this case, one cooling system can, for example, be used to prevent overheating of the battery cells during charging of the battery, with the result that both systems are used only when the battery is in use.

1.-5. (canceled)

6. A temperature-controlled battery, in particular as an energy source for a vehicle drive, having numerous flat battery cells which are electrically connected to one another and are combined parallel in relation to one another and with spacers, which are arranged between said battery cells and are distributed in a plurality of battery chambers, in a thermally insulated battery housing to form cell packs, wherein a free-flowing first heat carrier which is in contact with the battery cells is enclosed in the battery housing, said first heat carrier exchanging heat with at least one second heat carrier, which is enclosed in a channel system, by means of heat-transfer areas which are enclosed in the battery housing, said second heat carrier having at least one feed and discharge line, which is routed out of the battery, for temperature-controlled heat exchange outside the battery, and at least one pump is enclosed within the battery housing for forced convection at the battery cells, said pump forming a flow connection with the first heat carrier on the inflow and outflow side, wherein the channel system which has a feed and discharge line for temperature-controlled heat exchange outside the battery extends through a heat exchanger space which is provided between cell packs, is vertically oriented, is filled with the first heat carrier and communicates with spaces in the cell packs, which spaces are provided between the battery cells, by means of cavities in its base, wherein a plurality of miniature pumps are arranged in the heat exchanger space and consequently between the battery cells in the upper region of the heat exchanger space for forced convection, wherein a pressure pocket which is filled with a compressed gas is arranged in each pack of battery cells, with the result that the battery cells which are arranged in the battery chamber in question are held in said battery chamber in a clamping manner under the pressure of the gas, and wherein the intermediate chambers between the battery cells are formed by metallic spacers which are in thermally conductive contact with said battery cells and are composed of a metal sheet which has vertically running profile ribs, with the result that the profile ribs are in thermally conductive contact with the surface of adjacent battery cells.

7. The battery as claimed in claim 6, wherein the battery has a cover which can be fitted such that it is sealed off, and the pressure pockets have a filling connection which can be closed in a sealed manner, with the result that the pressure pockets can be placed under clamping pressure after the battery cells are inserted into a battery chamber in a clamping-free manner.
